(19) United States
(12) Patent Application Publication
(10) Pub. No.: US 2014/0252145 A1
(43) Pub. Date: Sep. 11, 2014

(54) Scanner-shredder combination unit with media speed detection and image correction based on media speed.

(71) Applicant: Alexndre Verbitski, Woodinville, WA (US)

(72) Inventor: Alexndre Verbitski, Woodinville, WA (US)

(21) Appl. No.: 13/792,192

(22) Filed: Mar. 11, 2013

(51) Int. Cl. B02C 25/00; B02C 18/00

(52) U.S. Cl. CPC B02C 25/00; B02C 18/0007
USPC 241/33

(57) ABSTRACT

A scanner system used in conjunction with a shredder apparatus incorporates plurality of a scanning element, media speed detection sensors, internal processing unit, and optionally media feed device. Such system performs image acquisition from the scanner element, measures the speed of the media through the device as it is pulled by the shredding apparatus and corrects the image acquired based on the speed measured. Processed images are stored on the digital media in optional encrypted form thus making it possible safe and secure storage of the shredded documents for the future retrieval.

### BACKGROUND OF THE INVENTION

Shredding machines are used in both office and home environment to both destroy unwanted documents and reduce clutter by eliminating already digitized documents. As the process of shredding is irreversible people have to keep number of documents which have even remote possibility of being useful in future. There are several companies which are promoting the model “take your paper receipts/bills, digitize them using our scanner and our software and after that dispose the paper document using shredder”. In most of the cases the digitized content would never be accessed again—for example if you are looking to tally your expenses credit cards and online banking offer you way more flexibility. By having computer software you are increasing complexity of the solution—you have to take care of the digitized content, store it securely, provide backups, update host OS software, etc.

On another side there are plenty of high-end document management system connected shredders suited well to the needs of office and legal requirements. They are expensive and contain a lot of features not usable by small office/home customers. For example, they may consult the central database to check if the document is indeed have to be destructed by scanning parts of the document and it's identifiers, could provide an evidence of the document being destroyed/etc

### BRIEF SUMMARY OF THE INVENTION

The proposal is to have a low-cost device which performs scanning of the documents already destined for shredding. In particular low-cost could be achieved by providing standalone device which performs processing of the image acquired and uses the drive unit of the shredding mechanism to advance paper past scanner element and compensates the image based on the speed of the movement of the media detected by the sensor.

Current cost of the storage media makes it feasible to store more than 100.000 of typed pages (likely more than one single person needs in a lifetime—see http://www.supportingadvancement.com/records/document_imaging_sizing/document_imaging_sizing.ht m for sizing information) in a single SD card of 64 GB size. This storage abundance together with the possible built-in redundant storage makes it possible to deliver “paper elimination” solutions which were too costly or complex in the past.

### PRIOR ART

Several of the prior inventions have collocated scanner and shredder (for example U.S. Pat. No. 5,354,001 Disposal device for reading, storing information from, and shredding paper documents, Takanori Hasegawa, U.S. Pat. No. 7,854,405 Document disposal apparatus, Shintaro Adachi, Tsutomu Kimura, Noriko Arai, Kenji Yamada, 2006028514 System and method for controlling the storage and destruction of documents, G. Jonathan Wolfman, Benjamin Singer). The difference is that to achieve low-cost solution current invention is using the same drive unit instead of separate scanning drive and shredder drive. In most of the patents a document is scanned by the separate “scanning subsystem” first then temporary stored then fed to the shredding unit. In many cases the document management system connection is required to validate the properties of the document—thus requiring temporary storage. Current patent deals with the documents always destined for the destruction and the scanning process coincides with the document destruction itself.

Both shredder devices and scanners are well known and referenced multiple times in the patent application. For example of the “shredder apparatus” definition utilized here closely matches U.S. Pat. No. 7,195,185 Shredder with separate waste opening, Tai Hoon Kim Matlin).

There is one patent which may be considered utilizing the same drive for the both shredder and scanner—(U.S. Pat. No. 8,289,588 Scanning shredder method and apparatus, David M. GURAK) but that invention places scanning unit after shredder and does not attempt to compensate for the possible uneven speed of the shredding.

Outside of the patents I could find the following references:

http://inventionpublicity.com/4215.pdf

Mentions scanner/shredder combination but without mentioning any details of possible operation to make a comparison valid.

http://designforpeople.ca/?p=215

No speed detection module is present and no detailed mode of operation.

http://www.halfbakery.com/idea/Shredder 20Scanner

Again, no speed detection module is present and no detailed mode of operation.

### DETAILED DESCRIPTION OF THE PREFERRED EMBODIMENT

An example of the device could be an attachment installed on top of the regular retail shredder using adhesive pads. This attachment contains
a) A receptacle for the pages of variable width
b) Scanning element which contains 2 scanner bars on both sides of the page with embedded lighting
c) Paper speed detector
d) Processing unit to process scanned data and adjust it based on the media speed
e) Double storage slot for the digital media on which the data would be stored with redundancy in a mirrored fashion

Paper sheets are inserted by the human into receptacle one by one. On the way down they travel past the scanning element and paper speed detector to the shredding unit on top of which a device is installed. As the paper is being picked up by the shredding gear its speed and direction would be changing but the paper speed detection module would be able to recognize these changes. Processing unit will be able to produce corrected image based on the scanner sensor data and the speed movement sensors and write it to the storage medium in encrypted form. It writes identical data to the storage media inserted into both slots for the redundancy purposes (or it could use one slot but in non-redundant manner).

When the need later arises to recover one of the documents media is manually moved by human from the device to the computer with appropriate storage card reader where the information could be read, decrypted and processed by variety of means outside of scope of this patent. For example, decryption key provided with the device could be stored by owner separately from the device in a secure location. After copying the decrypted files image viewing program could be used to navigate between then and lookup the relevant documents.

A lighting required for the scanning process could be provided by variety of means. There are active solution using LED diode arrays/CFL lamps commonly used for scanning equipment where the high quality scan is required. For cheaper solution simple setup could be exercised: for example several LED's in the scanning tube. This also allows to have some coloring effects (like to see that the paper is disappearing in a red glow or otherwise use light as indication whether the feeding mechanism is functioning correctly)

Normally scanner devices have a high-quality feeding mechanisms which ensure a great smoothness of the scanning element movement. Paper speed detectors are required in handheld scanners or in devices like the one described since speed of the media movement could vary. In the simplest case the speed could be measured very roughly by detecting media started/media finished event and assuming the media to be of one of the standard sizes and creating the image accordingly. A sophisticated device calls to the speed measurement based on non-contact approach typically used in optical mouse elements for the high-precision speed measurements.

Once the speed of the media past the scanning element is measured the central unit could use variety of well-known methods to adjust image: for example it could sample the scanning bar at the frequency proportional to the media movement speed. Other ways of correcting the image could be utilized as well (oversampling of the scanner data with averaging, etc).

Files on the storage could be either unencrypted or encrypted by one of the industry-standard algorithms. Encryption key could have been one supplied by the user or one embedded in the device at the manufacturing point and supplied either with the device. Encryption key could be dynamic and change over time and may need to be received over the separate channel at the later time with validation of identity of the owner of the said device.

1). An unit composed of the following: a media scanner which uses power of the shredding element as the main mean of the media advance and corrects image for the uneven speed of the media movement past scanner element by measuring the speed of media advance through the unit

2). The unit described in the claim 1 which is attached to the shredder unit by following means
a) The device can be just installed in a “feeding slot” of the shredder mechanism by closely matching the opening dimensions of the specific model of the shredder
b) Device could be attached using permanent adhesive
c) Device could be attached using adhesive pads
d) Device could be comprised from base which is attached by the means listed above and detachable portion (for example permanently glued base and removable top which have to be removed to clean up jams or to feed non-paper media to the shredder)
e) Device could be an integral part of the shredder.

3). The unit described in claim 1 which have a scanning element which may have some of the following properties
a) Black and white
b) Color
c) Contain embedded high-quality lighting system
d) Contain embedded passive reflecting element to improve lighting (think of the curved mirror bar)
e) Installed either for single-side scan or for scanning of both sides of the page

4). The unit described in claim 1 could be powered by the following means
a) Internal battery
b) Line power (separate power cord to the socket)
c) Line power+power outlet (device is plugged to the socket, shredder itself is plugged into device)
d) Internal generator+rechargeable battery and charging circuits (as the shredders are typically very powerful you could start harvest some of the power by which the shredder “pulls” paper sheeting into it. It is way less practical then any of the solutions above but still worth mentioning.

5). The unit described in claim 1 which measures speed of the media by one of these possible ways:
a) A contact roller with the circuit measuring the roller speed
b) A non-contact measurement (similar to the optical mouse element)
c) Purely software measurements based only on the data from the scanner element (by running software in the embedded processing unit or outside of the system on the images acquired and degrading the output from the resolution originally reported by the scanner element)

6). The unit described in claim 1 which is equipped with automatic single-feed mechanism, use continuous feed mechanism or simply slot in which document shredded should be installed page by page by human operator.

7). The unit described in claim 1 which is storing the data acquired and processed using of the following implementation:
a) A removable media (SD card slot in the device, CF card slot/etc)
b) Internal media storage (internal memory) with connection to the host computer
c) Combination of above.
d) Duplicated media (an example is 2 SD card slots and the data is written on both of them providing data redundancy)

8). The unit described in claim 1 which using internal processing unit to monitor the space available on the digital media and implement policies what is the required action when the empty space is no longer available:
a) Delete old files
b) Delete old files except the ones explicitly marked by user
c) Delete old unimportant files based on internal algorithm flagging “important” documents which runs on embedded processing unit
d) Provide visual indication that the storage is near capacity but continue operating
e) Stop when the space is exhausted or media is unavailable due to errors.

9). The unit described in claim 1 which using internal processing unit to store data on digital media in one of the following ways:
a) Plain image files
b) Image files together with a metadata (like the date stamp when they were acquired)
c) Internal processor running computer software could be used to recognize special types of documents, their significance and even content of them based on a number of rules. For example, for the tax form it could convert it to the proper filled tax form spreadsheet while potentially still preserving the original images with the signatures.
